(19) United States
(12) Patent Application Publication
(10) Pub. No.: US 2025/0173037 A1
(43) Pub. Date: May 29, 2025

(54) INFORMATION DISPLAY METHOD AND APPARATUS, ELECTRONIC DEVICE, COMPUTER-READABLE STORAGE MEDIUM, AND COMPUTER PROGRAM PRODUCT

(71) Applicant: Tencent Technology (Shenzhen) Company Limited, Shenzhen (CN)

(72) Inventors: Liangkun YU, Shenzhen (CN); Jiayin Zhang, Shenzhen (CN)

(73) Assignee: Tencent Technology (Shenzhen) Company Limited, Shenzhen (CN)

(21) Appl. No.: 19/040,939

(22) Filed: Jan. 30, 2025

Related U.S. Application Data
(63) Continuation of application No. PCT/CN2023/129921, filed on Nov. 6, 2023.

(30) Foreign Application Priority Data
Feb. 10, 2023 (CN) 202310154420.4

(51) Int. Cl. G06F 3/0481; G06F 16/29; G06F 16/9537; G06F 16/9538; G06F 40/169

(52) U.S. Cl. CPC G06F 3/0481; G06F 16/29; G06F 16/9537; G06F 16/9538; G06F 40/169

(57) ABSTRACT

An information display method, performed by an electronic device, includes displaying to-be-recognized information on a human-computer interaction interface, the human-computer interaction interface being configured to provide text information for reading; and displaying, based on the to-be-recognized information including geographical information, annotated information indicating the geographical information on the human-computer interaction interface, wherein the annotated information is configured for performing human-computer interaction processing on the geographical information when triggered.

### CROSS-REFERENCE TO RELATED APPLICATIONS

This application is a continuation application of International Application No. PCT/CN2023/129921 filed on Nov. 6, 2023, which claims priority to Chinese Patent Application No. 202310154420.4, filed with the China National Intellectual Property Administration on Feb. 10, 2023, the disclosures of each being incorporated by reference herein in their entireties.

### FIELD

The disclosure relates to the field of human-computer interaction technologies, and in particular, to an information display method and apparatus, an electronic device, a computer-readable storage medium, and a computer program product.

### BACKGROUND

Artificial intelligence (AI) involves a theory, a method, a technology, and an application system that use a digital computer or a machine controlled by the digital computer to simulate, extend, and expand human intelligence, perceive an environment, obtain knowledge, and use knowledge to obtain an optimal result.

In the related art, geographical information included in text or image information can only be displayed via a text or image format. However, an amount of information brought by displaying the geographical information in the text or image format is limited, and cannot truly meet a perception requirement and an interaction requirement of a user on the geographical information. Consequently, the efficiency of human-computer interaction for the geographical information is relatively low.

### SUMMARY

Provided are an information display method and apparatus, an electronic device, a computer-readable storage medium, and a computer program product.

According to an aspect of the disclosure, an information display method, performed by an electronic device, includes displaying to-be-recognized information on a human-computer interaction interface, the human-computer interaction interface being configured to provide text information for reading; and displaying, based on the to-be-recognized information including geographical information, annotated information indicating the geographical information on the human-computer interaction interface, wherein the annotated information is configured for performing human-computer interaction processing on the geographical information when triggered.

According to an aspect of the disclosure, an information display apparatus includes at least one memory configured to store computer program code; and at least one processor configured to read the program code and operate as instructed by the program code, the program code including first display code configured to cause at least one of the at least one processor to display to-be-recognized information on a human-computer interaction interface, the human-computer interaction interface being configured to provide text information for reading; and second display code configured to cause at least one of the at least one processor to display, based on the to-be-recognized information including geographical information, annotated information indicating the geographical information on the human-computer interaction interface, wherein the annotated information is configured for performing human-computer interaction processing on the geographical information when triggered.

According to an aspect of the disclosure, a non-transitory computer-readable storage medium, storing computer code which, when executed by at least one processor, causes the at least one processor to at least display to-be-recognized information on a human-computer interaction interface, the human-computer interaction interface being configured to provide text information for reading; and display, based on the to-be-recognized information including geographical information, annotated information indicating the geographical information on the human-computer interaction interface, wherein the annotated information is configured for performing human-computer interaction processing on the geographical information when triggered.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1A to FIG. 1D are schematic diagrams of an interface of an information display method in the related art.

FIG. 2 is a schematic structural diagram of an information display system according to some embodiments.

FIG. 3 is a schematic structural diagram of an electronic device according to some embodiments.

FIG. 4A to FIG. 4D are schematic flowcharts of an information display method according to some embodiments.

FIG. 5 is a schematic diagram of an interface of an information display method according to some embodiments.

FIG. 6 is a schematic diagram of an interface of an information display method according to some embodiments.

FIG. 7 is a schematic diagram of an interface of an information display method according to some embodiments.

FIG. 8 is a schematic flowchart of an information display method according to some embodiments.

FIG. 9 is a schematic flowchart of an information display method according to some embodiments.

FIG. 10 is a timing diagram of an information display method according to some embodiments.

FIG. 11 is a timing diagram of an information display method according to some embodiments.

FIG. 12 is a schematic diagram of feature recognition of an information display method according to some embodiments.

FIG. 13 is a schematic diagram of an interface of an information display method according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

The terms, involved in the following description, “first/second/third” are merely intended to distinguish similar objects rather than describing specific orders. It is to be understood that, “first/second/third” is interchangeable in proper circumstances to enable some embodiments to be implemented in other orders than those illustrated or described herein.

Unless otherwise defined, meanings of all technical and scientific terms used are the same as those understood by a person skilled in the art. Terms used herein are merely intended to describe objectives of some embodiments, but are not intended to limit the scope of the disclosure.

Before some embodiments are further described in detail, a description is made on nouns and terms in some embodiments, and the nouns and terms in some embodiments are applicable to the following explanations.

1) Address location: The address location refers to a dialog card generated when a user shares a location in a dialog in social software. The dialog card displays a place name and address information, and can be directly clicked to view details of a map. The address location may be a hyperlink that can be directly clicked to view details of the map.

2) Point of Interest (POI): In a geographical information system, a point of interest may be a landmark such as a house, a store, a mailbox, or a bus station.

3) Optical Character Recognition (OCR) refers to a process of recognizing and converting text in an image into a machine-readable text format, reduces a storage amount of image data, allows the recognized text to be reused for analysis, and saves manpower and time associated with manual keyboard input.

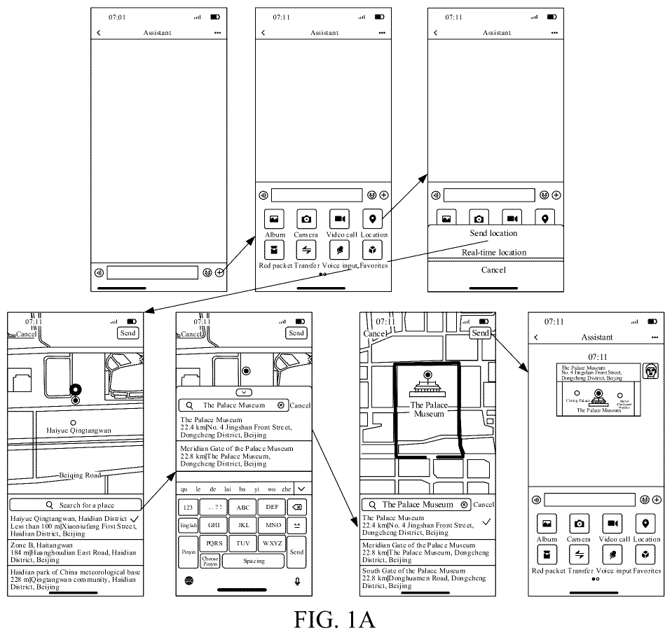

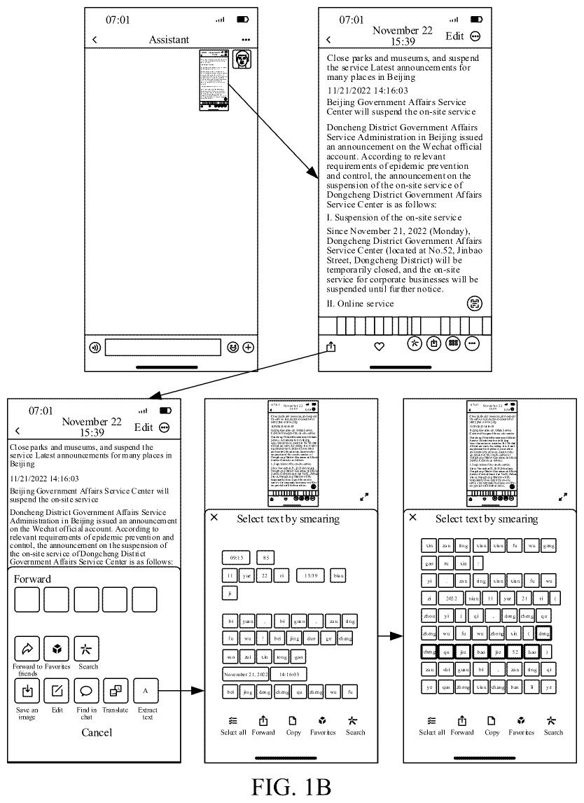

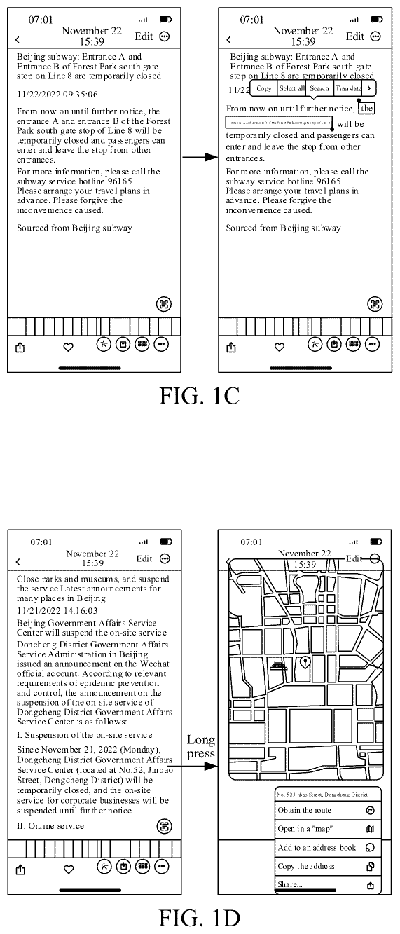

A human-computer interaction mode of geographical information in related art may be sending the geographical information in a plain text form. After the plain-text information is input by a sender into a dialog input box, the plain-text information is directly transmitted. After receiving plain-text location information, an information receiver may manually copy text and search for a location, which causes poor experience. Referring to FIG. 1A, a trigger operation for a location transmitting entry is received; a location input area is displayed; a candidate geographical matching result is displayed in response to a geographical information input operation at the location input area; and a dialog card is transmitted to an information receiver in response to a confirmation operation and a transmitting operation for the geographical matching result. The dialog card displays a place name and address information, and can be directly clicked to view map details.

In the related art, functions of recognizing and copying text in an image are provided, but the functions are independent of each other. Referring to FIG. 1B, the user may long-press the image to actively trigger, search for, and copy the text related to the geographical information. This creates a high learning and operation threshold, and interaction on the geographical information lacks targeted optimization.

Referring to FIG. 1C, in the related art, functions of long-pressing a picture and copying text in an area clicked by a finger are further supported. Referring to FIG. 1D, after an album is opened, for geographical information in an image, the technology allows a user to long-press the geographical information to directly trigger a map preview pop-up window. In a case of no prompt of geographical information in the image, the user can only recognize which text in the image is geographical information, and then long-press and view the text one by one. Moreover, the user can only be supported to view address information, but cannot view place name information.

In the related art, an information receiver may manually copy text and search for a location. A procedure of effectively sharing the geographical information is relatively long, and creates a learning operation threshold. An interaction scene of the geographical information lacks targeted optimization, the geographical information in an image lacks direct annotation and guidance, and can only be viewed one by one, and user recognition, learning, and operation thresholds are relatively high. In conclusion, the efficiency of human-computer interaction may be extremely low in actual use.

Some embodiments provide an information display method and apparatus, an electronic device, a computer-readable storage medium, and a computer program product, which can improve the efficiency of human-computer interaction for geographical information.

The following describes exemplary applications of the electronic device provided in some embodiments. The electronic device provided in some embodiments may be a server. Exemplary applications are described below when the electronic device is implemented as a server.

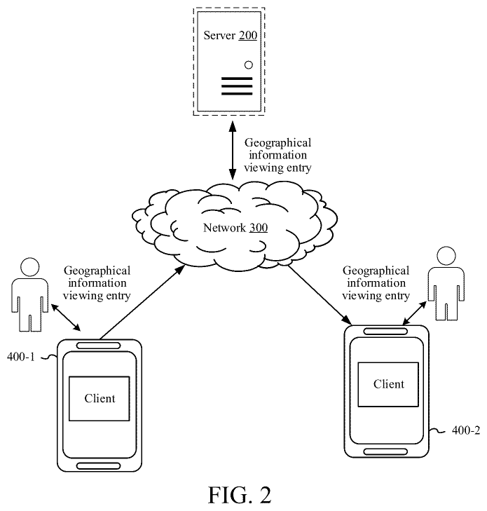

Referring to FIG. 2, FIG. 2 is a schematic structural diagram of an information display system according to some embodiments. To support a social application, a terminal 400-1 and a terminal 400-2 are connected to an application server 200 via a network 300. The network 300 may be a wide area network, a local area network, or a combination thereof. A first account logs in to a social client running on the terminal 400-1, to-be-recognized information inputted by the first account is displayed in a dialog box (the dialog box between the first account and a second account) of the terminal 400-1, and when the to-be-recognized information is recognized as including geographical information, annotated information configured for indicating the geographical information is displayed on the human-computer interaction interface. In response to a trigger operation for the annotated information, a viewing entry of the geographical information is transmitted, by a server 200, to the terminal 400-2 to which the second account logs in. The viewing entry of the geographical information is displayed in a dialog box (the dialog box between the first account and the second account) of the terminal 400-2. In response to a trigger operation performed on the viewing entry by the second account, an electronic map is displayed and a location indicated by the geographical information is annotated on the electronic map.

In some embodiments, the terminal may implement the information display method according to some embodiments by running a computer program. For example, the computer program may be a native program or a software module in an operating system; the computer program may be a native application (APP), i.e. a program that may be installed in an operating system to run, such as a social APP (i.e. the foregoing client); the computer program may be an applet, i.e. the program that may be run only after being downloaded into a browser environment; or the computer program may be a game applet that can be embedded into any APP. The computer programs may be any form of applications, modules, or plug-ins.

Some embodiments may be implemented by using a cloud technology. The cloud technology refers to a hosting technology that unifies a series of resources such as hardware, software, and networks within a wide area network or a local area network to implement calculation, storage, processing, and sharing of data.

The cloud technology is a term of network technology, information technology, integration technology, management platform technology, and application technology based on cloud computing business modes, which may form a resource pool and be used on demand, and is flexible and convenient. The cloud computing technology may become an important support. A background service of a technical network system may use a large amount of computing and storage resources.

As an example, the server 200 may be an independent physical server, or a server cluster or distributed system including a plurality of physical servers, or may be a cloud server providing cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The terminal may be a smartphone, a tablet computer, a notebook computer, a desktop computer, a smart speaker, a smart watch, or the like, but is not limited thereto. The terminal and the server 200 may be directly or indirectly connected in a wired or wireless communication mode, and this is not limited.

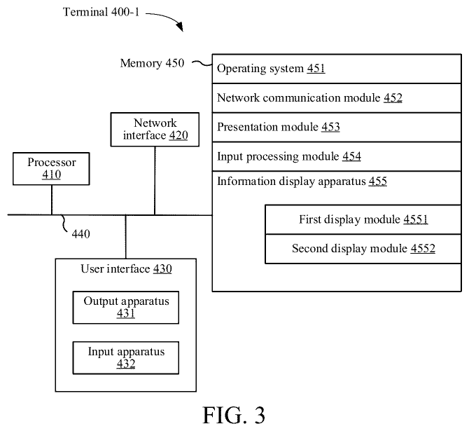

Referring to FIG. 3, FIG. 3 is a schematic structural diagram of an electronic device using the information display method according to some embodiments. The electronic device being the terminal is taken as an example for description. As shown in FIG. 3, a terminal 400-1 includes: at least one processor 410, a memory 450, at least one network interface 420, and a user interface 430. Components in the terminal are coupled by a bus system 440. The bus system 440 is configured to implement connection and communication between the components. In addition to a data bus, the bus system 440 further includes a power bus, a control bus, and a state signal bus. However, for ease of clear description, all types of buses in FIG. 3 are marked as the bus system 440.

The processor 410 may be an integrated circuit chip with signal processing capacity such as a central processing unit (CPU), a digital signal processor (DSP), another programmable logic device, discrete gate or transistor logic device, or discrete hardware assembly, or the like. The CPU may be a microprocessor or any processor, and the like.

The user interface 430 includes one or more output devices 431 that can show the medium content, including one or more speakers and/or one or more visual display screens. The user interface 430 further includes one or more input devices 432, including a user interface component facilitating the input of the user, such as a keyboard, a mouse, a microphone, a touch display screen, a camera, another input button, and a control.

The memory 450 may be removable, irremovable or a combination thereof. The exemplary hardware device includes a solid memory, a hard disk drive, an optical disk drive, and the like. The memory 450 in some embodiments includes one or more storage devices that are physically located away from the processor 410.

The memory 450 includes a volatile memory or a non-volatile memory, or may include both the volatile memory and the non-volatile memory. The non-volatile memory may be a read only memory (ROM), and the volatile memory may be a random access memory (RAM). The memory 450 described in some embodiments aims at including various types of memories.

In some embodiments, the memory 450 can store data to support various operations. An example of these data includes a program, a module, and a data structure or a subset or a superset thereof, which may be exemplarily described below.

An operating system 451 includes system programs for processing various system services and executing hardware-related tasks, such as a frame layer, a core library layer, and a drive layer, and is configured to implement various services and process hardware-based tasks.

A network communication module 452 is configured to reach another computing device through one or more (wired or wireless) network interfaces 420. An example of the network interface 420 includes: Bluetooth, a wireless fidelity (WiFi), universal serial bus (USB), and the like.

A presentation module 453 is configured to enable presentation of information through one or more output devices 431 (such as a display screen and a speaker) associated with the user interface 430 (for example, a user interface configured to operate a peripheral device and display content and information).

An input processing module 454 is configured to detect one or more user inputs or interactions from one of one or more input devices 432 and translate the detected inputs or interactions.

In some embodiments, the information display apparatus provided in some embodiments may be implemented in a software manner. FIG. 3 shows an information display apparatus 455 stored in the memory 450. The apparatus may be software in the form of a program, a plug-in, and the like, and includes the following software modules: a first display module 4551 and a second display module 4552. These modules are logical, and therefore can be arbitrarily combined or separated according to implemented functions. The functions of each module may be described below.

According to some embodiments, each module may exist respectively or be combined into one or more modules. Some modules may be further split into multiple smaller function subunits, thereby implementing the same operations without affecting the technical effects of some embodiments. The modules are divided based on logical functions. In actual applications, a function of one module may be realized by multiple modules, or functions of multiple modules may be realized by one module. In some embodiments, the apparatus may further include other modules. In actual applications, these functions may also be realized cooperatively by the other modules, and may be realized cooperatively by multiple modules.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

The following describes the information display method according to some embodiments with reference to an exemplary application and implementation of the terminal provided in some embodiments.

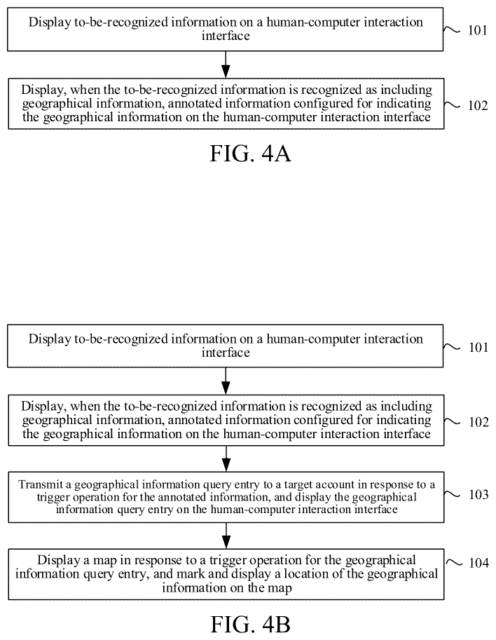

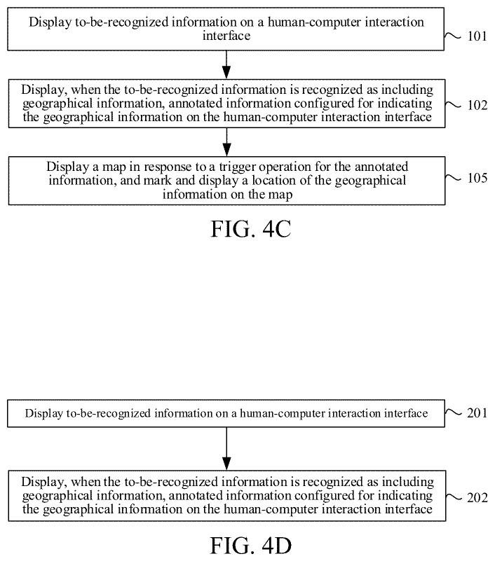

Referring to FIG. 4A, FIG. 4A is a schematic flowchart of an information display method according to some embodiments. Description is to be provided with reference to operations shown in FIG. 4A.

Operation 101: Display to-be-recognized information on a human-computer interaction interface configured to provide text information for reading.

As an example, the text information for reading may be dialog content displayed via an input operation. The dialog content may be read by a message receiver, or may be an article being read by a user. The to-be-recognized information includes image information and text information. For example, the image information may be an image displayed in a picture APP, or the image information may be an image transceived as a message in a social APP. The image information herein includes text. The text information may be text in a document, the text information may be text in a web page, or the text information may be text transceived as a message in the social APP.

In some embodiments, the displaying to-be-recognized information on a human-computer interaction interface configured to provide text information for reading in operation 101 may be implemented by using the following technical scheme: performing any one of the following processing: displaying viewed text information as the to-be-recognized information on the human-computer interaction interface in response to a text viewing operation; displaying inputted text information as the to-be-recognized information in a text input area of the human-computer interaction interface in response to a text input operation; and displaying at least one candidate image, the candidate image including text information, and displaying a preview image as the to-be-recognized information on the human-computer interaction interface in response to an image preview operation, the image being derived from the at least one candidate image. In some embodiments, a function of triggering the geographical information can be extended to text viewing, text input, and image preview scenes, whereby a geographical information recognition triggering function is implemented in a composite scene.

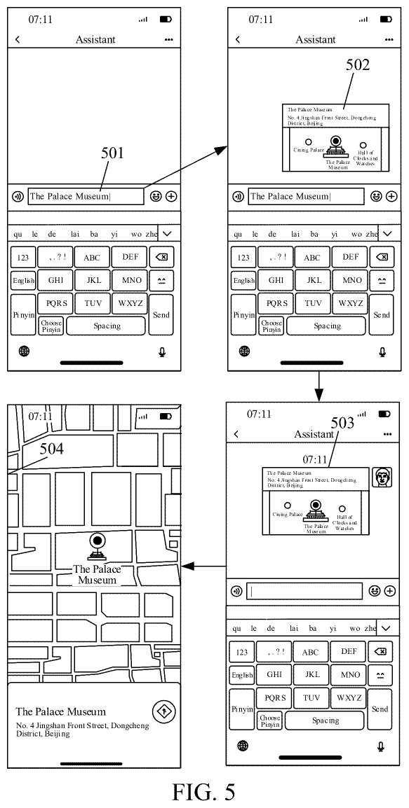

As an example, the to-be-recognized information may be text, the text viewing operation may be a click viewing operation on an existing document, and the text input operation may be a text input operation in a dialog input box of a social APP. Referring to FIG. 5, a dialog input box 501 shown in FIG. 5 displays text inputted by a user. The to-be-recognized information may be an image, and the candidate image may be an image displayed on the human-computer interaction interface of the photo APP, such as a screenshot of a document. The candidate image may be an image transceived as a message in the dialog box of the social APP. Some embodiments may be applied to a social client, an input method, and a photo client.

Operation 102: Display, when the to-be-recognized information is recognized as including the geographical information, annotated information configured for indicating the geographical information on the human-computer interaction interface.

As an example, the annotated information is configured for performing human-computer interaction processing on the geographical information when triggered. The human-computer interaction processing may be sharing the geographical information or viewing a location indicated by the geographical information on a map.

In some embodiments, the displaying annotated information configured for indicating the geographical information on the human-computer interaction interface in operation 102 may be implemented by using the following technical scheme: when there is one piece of geographical information, at least one piece of annotated information is displayed on the human-computer interaction interface in a manner independent from the to-be-recognized information, the at least one piece of annotated information being configured for indicating the geographical information; and when there is a plurality of pieces of geographical information, for each piece of geographical information, at least one piece of annotated information is displayed on the human-computer interaction interface in a manner independent from the to-be-recognized information, the at least one piece of annotated information being configured for indicating the geographical information. According to some embodiments, the corresponding annotated information that is used as a candidate may be separately displayed for each piece of geographical information and allows the user to make a selection, thereby avoiding situation where incorrect recognition leads to a lack of annotated information that can be triggered by the user.

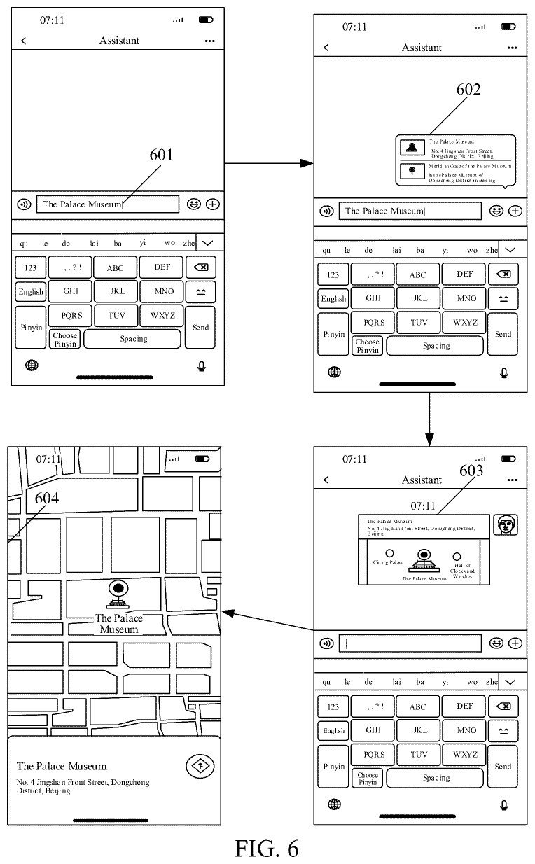

As an example, referring to FIG. 5, FIG. 5 shows an example in which there is one piece of geographical information. When text includes characters representing the geographical information, a bubble 502 of the corresponding geographical information pops up in the dialog box. The bubble 502 carries the annotated information configured for indicating the geographical information. For example, the geographical information is the Palace Museum, and the annotated information includes a place name associated with the geographical information and address information corresponding to the place name. Referring to FIG. 6, when text includes characters representing the geographical information, a bubble 602 of the corresponding geographical information pops up in the dialog box, and the bubble 602 carries a plurality of pieces of annotated information corresponding to the geographical information. For example, the geographical information is the Palace Museum, the annotated information A includes a place name A associated with the geographical information and address information A corresponding to the place name, and the annotated information B includes another place name B associated with the geographical information and address information B corresponding to the place name.

In some embodiments, the displaying the at least one piece of annotated information on the human-computer interaction interface in a manner independent from the to-be-recognized information may be implemented by using the following technical schemes: displaying a place name and address information corresponding to the place name in an area independent from the to-be-recognized information on the human-computer interaction interface, the place name being matched with the geographical information. According to some embodiments, the annotated information can be clearly displayed, and more information is provided for the user.

As an example, referring to FIG. 5, the bubble 502 of the corresponding geographical information pops up in the dialog box. The bubble 502 carries the annotated information configured for indicating the geographical information. For example, the geographical information is the Palace Museum, the annotated information includes a place name “the Palace Museum” associated with the geographical information and address information “No. 4 Jingshan Qianjie, Dongcheng District, Beijing” corresponding to the place name. The annotated information further includes a map identifier representing the place name.

In some embodiments, when there is a plurality of pieces of annotated information, the displaying the at least one piece of annotated information on the human-computer interaction interface in a manner independent from the to-be-recognized information may be implemented by using the following technical schemes: arranging and displaying the plurality of pieces of annotated information on the human-computer interaction interface according to a particular order of the plurality of pieces of annotated information, the particular order including at least one of the following: a descending order of matching degrees between the annotated information and the geographical information, a descending order of a number of times of performing the human-computer interaction processing on the annotated information, and a descending order of detailed degrees of the annotated information. According to some embodiments, a function of recommending the annotated information may be provided, and allows a user to select the annotated information meeting a user requirement, thereby improving the human-computer interaction efficiency.

As an example, for example, when there is a plurality of pieces of annotated information, a plurality of pieces of annotated information may be displayed for one piece of geographical information. Referring to FIG. 6, two pieces of annotated information, i.e. “the Palace Museum” and “the Meridian Gate of the Palace Museum”, are displayed for the geographical information “the Palace Museum”. The two pieces of annotated information are displayed in order. For example, as shown in FIG. 6, the annotated information “the Palace Museum” that has a highest matching degree with the geographical information “the Palace Museum” is displayed at a first location, or the annotated information on which the human-computer interaction processing is performed for the highest number of times is displayed at the first location. The human-computer interaction processing herein may be a clicking operation for some annotated information in a bubble as shown in FIG. 6. The detailed degree of the annotated information refers to a level of details of the annotated information. For example, the level of details of “the Meridian Gate of the Palace Museum” is higher than that of “the Palace Museum”.

In some embodiments, when there is a plurality of pieces of annotated information, the displaying, on the human-computer interaction interface, at least one piece of annotated information configured for indicating geographical information in a manner independent from the to-be-recognized information may be implemented by using the following technical scheme: displaying a plurality of pieces of annotated information on the human-computer interaction interface based on a significance level of differentiation, the significance level of the annotated information being in positive correlation with a first feature parameter of the annotated information, and the first feature parameter including at least one of the following: a matching degree between the annotated information and the geographical information, a number of times of performing the human-computer interaction processing on the annotated information, and a detailed degree of the annotated information. According to some embodiments, it can help the user to select the annotated information, thereby improving the human-computer interaction efficiency.

As an example, a higher matching degree between the annotated information and the geographical information indicates a higher significance level of the annotated information, a higher number of times of performing the human-computer interaction processing on the annotated information indicates a higher significance level of the annotated information, or a higher detailed degree of the annotated information indicates a higher significance level of the annotated information. The significance level may be quantified by using a display parameter of the annotated information. A higher display parameter represents a higher significance level, the display parameter including a size of a display area, a font size of the annotated information, display brightness of the annotated information, and display contrast of the annotated information.

In some embodiments, the displaying annotated information configured for indicating the geographical information on the human-computer interaction interface in operation 102 may be implemented by using the following technical scheme: displaying, on the geographical information, the annotated information corresponding to the geographical information in a covering manner; or performing special effect rendering processing on the geographical information, and displaying an obtained special effect rendering style as the annotated information, an area in which the geographical information is located being in a triggerable state. According to some embodiments, the annotated information may be closely associated with the geographical information, whereby the user can directly perceive the association between the geographical information and the annotated information, and the human-computer interaction efficiency is accordingly improved.

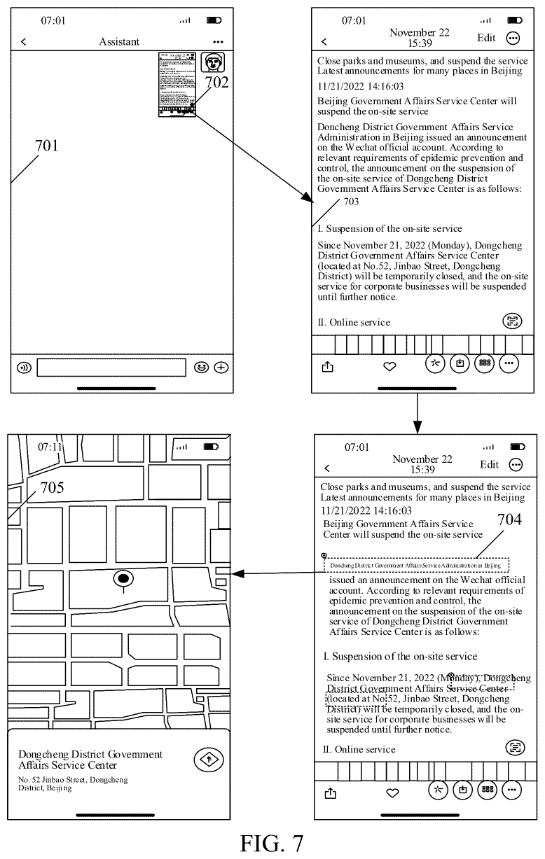

As an example, referring to FIG. 7, the annotated information may not be specific text. The annotated information may be a mask layer. The mask layer directly covers the geographical information, and the covered geographical information is distinguished from the to-be-recognized information, thereby playing a role in indicating the geographical information. The annotated information may be a special effect rendering style. For example, a font color of the geographical information is changed to blue, and the blue font style is used as the annotated information to distinguish the rendered geographical information from the to-be-recognized information, thereby playing a role in indicating the geographical information.

In some embodiments, referring to FIG. 4B, when the to-be-recognized information is to-be-transmitted information, after the annotated information configured for indicating the geographical information is displayed on the human-computer interaction interface, operation 103 to operation 104 may further be performed.

Operation 103: Transmit a geographical information query entry to a target account in response to a trigger operation for the annotated information, and display the geographical information query entry on the human-computer interaction interface.

In some embodiments, when there is a plurality of pieces of geographical information, the displaying the geographical information query entry on the human-computer interaction interface in operation 103 may be implemented by using the following technical scheme: displaying a plurality of pieces of shared information corresponding to the target account on the human-computer interaction interface, each piece of shared information including the geographical information query entry corresponding to one piece of geographical information; or displaying one piece of shared information corresponding to the target account on the human-computer interaction interface, the shared information being obtained by performing replacement processing on the geographical information in the to-be-recognized information, and each piece of geographical information being replaced by the corresponding geographical information query entry. According to some embodiments, a user directly views a map via the geographical information query entry conveniently, thereby improving the actual transceiving efficiency of the geographical information.

As an example, referring to FIG. 5, a dialog input box 501 displays text inputted by a user. When the text includes characters representing geographical information, a bubble 502 of the corresponding geographical information pops up in the dialog box. A card 503 of the corresponding geographical information is transmitted in response to a trigger operation for the bubble 502. The card 503 includes a geographical information query entry. If there is a plurality of pieces of geographical information, the geographical information query entry is transmitted for each piece of geographical information. Referring to FIG. 13, an address result of the corresponding geographical information may be further displayed by using a hyperlink, or hyperlinks of a plurality of locations may be displayed in a paragraph of text. The paragraph of text is the shared information, and the shared information is obtained by replacing the geographical information in the to-be-recognized information. The geographical information is separately replaced with the geographical information query entry. The geographical information query entry may be in a hyperlink style. There may be a plurality of hyperlink styles, which may be clickable styles such as underlining, italicized text that turns blue, or an arrow displayed at the end.

In some embodiments, the displaying, on the human-computer interaction interface, a plurality of pieces of shared information corresponding to the target account may be implemented by using the following technical schemes: arranging and displaying, on the human-computer interaction interface, the shared information corresponding to the geographical information according to an order of appearance of the geographical information in the to-be-recognized information; or arranging and displaying, on the human-computer interaction interface, the shared information corresponding to the geographical information in descending order of a number of times of performing the human-computer interaction processing on the geographical information. Some embodiments may help a user make a selection, thereby improving the human-computer interaction efficiency.

As an example, when there is a plurality of pieces of shared information, the shared information may be arranged and displayed in an order. For example, the shared information corresponding to the geographical information performed with more times of human-computer interaction processing is displayed at a front position, and the shared information corresponding to the geographical information performed with less times of human-computer interaction processing is displayed at a rear position. For example, the shared information corresponding to the geographical information that appears first in the to-be-recognized information is displayed at a front position, and the shared information corresponding to the geographical information that appears later in the to-be-recognized information is displayed at a rear position.

Operation 104: Display a map in response to a trigger operation for the geographical information query entry, and mark and display a location of the geographical information on the map.

As an example, referring to FIG. 5, the dialog input box 501 displays text inputted by a user. When the text includes characters representing the geographical information, a bubble 502 of the corresponding geographical information pops up in the dialog box. In response to a trigger operation for the bubble 502, a card 503 corresponding to the geographical information is transmitted. In response to a trigger operation for the card 503, a map 504 is opened to view a location indicated by the geographical information.

In some embodiments, referring to FIG. 4C, when the to-be-recognized information is previewed information, after displaying, on the human-computer interaction interface, the annotated information configured for indicating the geographical information, operation 105 may further be performed.

Operation 105: Display a map in response to a trigger operation for the annotated information, and mark and display a location of the geographical information on the map.

As an example, referring to FIG. 7, a thumbnail 702 is displayed on a human-computer interaction interface 701, a preview image 703 is displayed in response to a trigger operation for the thumbnail 702, the geographical information is automatically annotated as a clickable style 704 in the preview image 703, and in response to a trigger operation for the clickable style 704, a map 705 is opened to view a location of the geographical information.

In some embodiments, a manual recognition entry is displayed; and in response to a closing operation for the manual recognition entry, the to-be-recognized information is determined to be in an automatic recognition state, and recognition processing for the geographical information is performed on the to-be-recognized information.

In some embodiments, a manual recognition entry is displayed; and in response to an opening operation for the manual recognition entry, the to-be-recognized information is determined to be in a manual recognition state; and in response to a trigger operation for the to-be-recognized information, recognition processing for the geographical information is performed on the to-be-recognized information.

As an example, automatic recognition may be performed on each image, or a switch may be set for an automatic recognition function. In addition to the automatic recognition, it may be set to support manual click recognition by a user. For example, when a manual recognition mode is enabled, the image is recognized in response to a trigger operation performed by the user on the image, and the geographical information included in the image is recognized, thereby effectively reducing the consumption of computational power.

In some embodiments, referring to FIG. 4D, FIG. 4D is a schematic flowchart of an information display method according to some embodiments. Description is made in conjunction with operations shown in FIG. 4D.

Operation 201: Display to-be-recognized information on a human-computer interaction interface.

As an example, the to-be-recognized information is other information than electronic map information. The electronic map information herein refers to an electronic map on a front page of a map APP or an electronic map on a map applet. The to-be-recognized information includes image information and text information. For example, the image information may be an image displayed on a photo APP, and the image information may be an image transceived as a message on a social APP; the image information may be image information including text, or may be image information without text; and the text information may be text in a document, the text information may be text on a web page, or the text information may be text transceived as a message on the social APP.

In some embodiments, the displaying to-be-recognized information on a human-computer interaction interface configured to provide text information for reading in operation 201 may be implemented by using the following technical scheme: performing any one of the following processing: displaying viewed text information as the to-be-recognized information on the human-computer interaction interface in response to a text viewing operation; displaying inputted text information as the to-be-recognized information in a text input area of the human-computer interaction interface in response to a text input operation; and displaying at least one candidate image, the candidate image including text information, and displaying a preview image as the to-be-recognized information on the human-computer interaction interface in response to an image preview operation, the image being derived from the at least one candidate image.

As an example, the to-be-recognized information may be text, the text viewing operation may be a click viewing operation for an existing document, and the text input operation may be a text input operation in a dialog input box of a social APP. Referring to FIG. 5, a dialog input box 501 shown in FIG. 5 displays text inputted by a user; and the to-be-recognized information may be an image, the candidate image may be an image displayed on a human-computer interaction interface of a photo APP, or the candidate image may be an image transceived as a message in a dialog box of the social APP. Some embodiments may be applied to a social client, an input method, and a photo client.

Operation 202: Display, when the to-be-recognized information is recognized as including the geographical information, annotated information configured for indicating the geographical information on the human-computer interaction interface.

As an example, the annotated information is configured for performing human-computer interaction processing on the geographical information when triggered. The human-computer interaction processing may be sharing the geographical information or viewing a location indicated by the geographical information on a map. The geographical information may be presented in the to-be-recognized information in a text form, or the geographical information may be presented in the to-be-recognized information in an image form. For example, the to-be-recognized information is a document screenshot. Characters “the Palace Museum” presented in the document screenshot are geographical information. The to-be-recognized information may be a photo of the Palace Museum. A building image presented in the photo may be recognized as the geographical information.

For implementation details of operation 201 and operation 202 in some embodiments, refer to the descriptions of operation 101 and operation 102.

An exemplary application of some embodiments in an actual application scenario is described below.

An application scenario of some embodiments may be a social application, an input method application, or an album application. In a social application scenario, the geographical information may be shared between users. For example, a user A may notify a user B of a dating place (the Forbidden City). Users may have more information mining requirements on the geographical information, for example, the users further may obtain location information of the Forbidden City. Terminals are connected to an application server through a network, and the network may be a wide area network, a local area network, or a combination thereof. A first account logs in to a social client running on the terminal, to-be-recognized information inputted by the first account is displayed in a dialog box (the dialog box between the first account and a second account) of the terminal, and when the to-be-recognized information is recognized as including the geographical information, annotated information configured for indicating the geographical information is displayed on the human-computer interaction interface; and In response to a trigger operation for the annotated information, a viewing entry for the geographical information is transmitted to the terminal to which the second account logs in by using a server, the viewing entry of the geographical information is displayed in a dialog box (the dialog box between the first account and the second account) of the terminal, and in response to a trigger operation for the viewing entry of the second account, an electronic map is displayed and a location indicated by the geographical information is annotated on the electronic map.

In some embodiments, referring to FIG. 5, a dialog input box 501 displays text inputted by a user. When the text includes characters representing geographical information, a bubble 502 of the corresponding geographical information pops up in the dialog box. In response to a trigger operation for the bubble 502, a card 503 corresponding to the geographical information is transmitted. In response to a trigger operation for the card 503, a map 504 is opened to view a location indicated by the geographical information.

In some embodiments, referring to FIG. 6, a dialog input box 601 displays text inputted by a user. When the text includes characters representing geographical information, a bubble 602 of the corresponding geographical information pops up in the dialog box. The bubble 602 includes a plurality of matching results corresponding to the geographical information. In response to a trigger operation for any matching result, a card 603 corresponding to the geographical information is transmitted. In response to a trigger operation for the card 603, a map 604 is opened to view a location indicated by the geographical information.

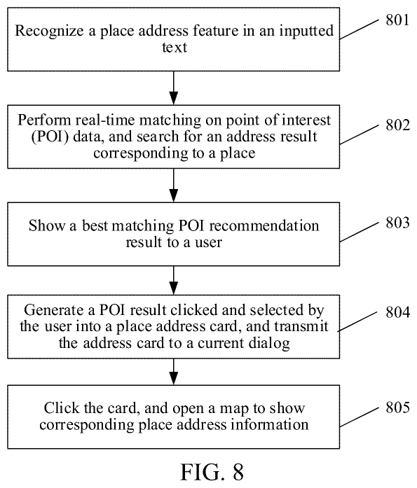

In some embodiments, referring to FIG. 8, FIG. 8 shows a process of transmitting an address card based on inputted text. Operation 801: Recognize an address feature in the inputted text. Operation 802: Perform real-time matching processing on point of interest data, to search for an address corresponding to geographical information. Operation 803: Display a best matching address. Operation 804: Generate an address card based on an address that is clicked and selected by a user, and transmit the address card to a dialog. Operation 805: Display a map in response to a trigger operation for the card, and display, on the map, a location indicated by the geographical information. When the address feature in the inputted text is recognized, point of interest retrieval is performed by using text that conforms to the address feature, and an address in the point of interest data is matched in real time. When a matching result is obtained, the matching result is shown on a current dialog page in real time and recommended to a user, and thus the user can directly click the matching result to transmit the matching result to the current dialog. If the user clicks a matching result among the plurality of matching results, an address card is generated based on the matching result, and is transmitted to the current dialog. In response to a trigger operation for the address card, a map page is opened and a location indicated by the geographical information is shown.

In some embodiments, referring to FIG. 7, a thumbnail 702 is displayed on a human-computer interaction interface 701. A preview image 703 is displayed in response to a trigger operation for the thumbnail 702, and geographical information is automatically annotated as a clickable style 704 in the preview image 703; and in response to a trigger operation for the clickable style 704, a map 705 is opened to view a location of the geographical information. In one image, at least one piece of geographical information may be recognized and annotated.

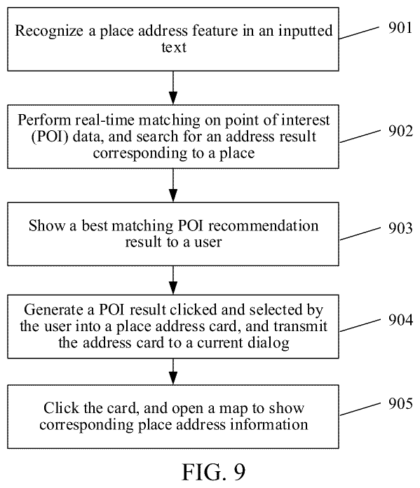

In some embodiments, referring to FIG. 9, FIG. 9 shows a process of viewing an address based on an image. Operation 901: Recognize text information in an image by using an optical character recognition (OCR) technology. Operation 902: Scan and screen a field that conforms to an address feature in the text. Operation 903: Perform real-time matching processing on point of interest data to search for an address corresponding to the geographical information. Operation 904: Annotate the field that conforms to the address feature in the image as a clickable address hyperlink. Operation 905: in response to a trigger operation for the hyperlink, display a map, and display, on the map, a location indicated by the geographical information. A difference between the manner of viewing the address based on the image and the foregoing process of transmitting the address card based on the text inputted by the user lies in that: first, all characters in the image are recognized by using the OCR technology to screen the field conforming to the address feature. Searching processing is performed on the point of interest data based on the field conforming to the address feature, and an address result is obtained by matching. According to the address result obtained by matching, the geographical information is annotated as a clickable hyperlink style at the location corresponding to the geographical information on the image; and in response to a trigger operation for the hyperlink, a map is opened and a location indicated by the geographical information is shown.

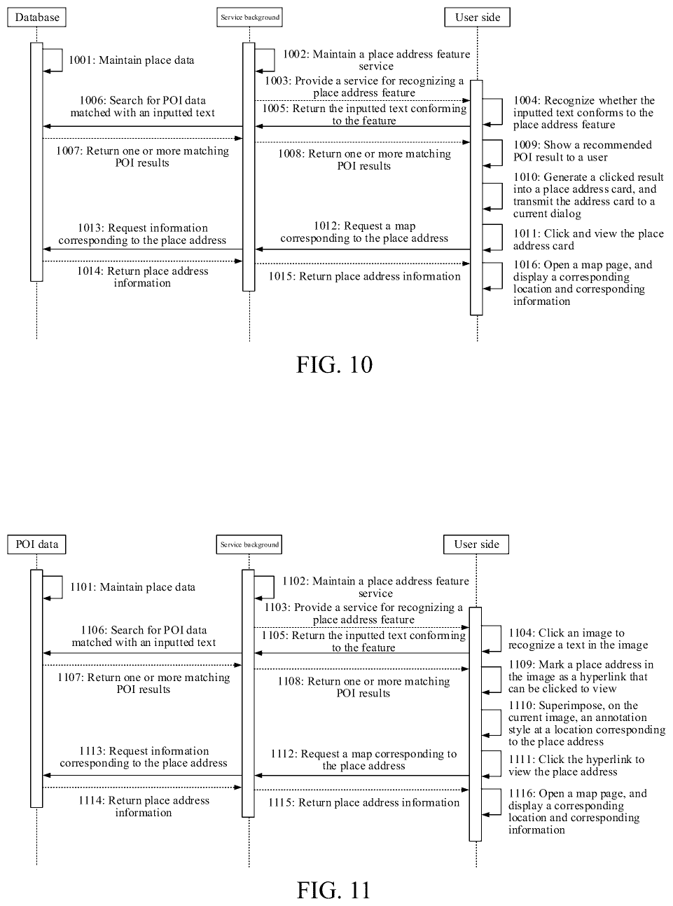

In some embodiments, referring to FIG. 10, FIG. 10 is a timing diagram of address sharing and viewing based on text input. Operation 1001: Perform maintenance processing on point of interest data. Operation 1002: Perform maintenance processing on an address feature, and a service background maintains an address feature service. Operation 1003: Provide an address feature recognition service for a terminal. Operation 1004: Recognize characters that conform to the address feature from the inputted text. Operation 1005: Return the characters that conform to the address feature. When the inputted text conforms to the address feature, the service background queries a point of interest (POI) database by using an inputted keyword, to search for whether there is matching point of interest data. Operation 1006: Search for the point of interest data matched with the characters. Operation 1007: Return at least one piece of point of interest data to a server. Operation 1008: Return at least one piece of point of interest data (an address result) to the terminal. Operation 1009: Display the address result. When there is at least one piece of point of interest data, the point of interest data is returned to a client by the service background, and at least one piece of point of interest data is presented to the user on a dialog page. Operation 1010: Generate the address result into an address card, and transmit the address card to a dialog. When the user clicks a piece of point of interest data, the point of interest data is transmitted as the address card to the dialog. Operation 1011: Click and view the address card. Operation 1012: Request map information of a corresponding address from a server. Operation 1013: Request address information of the corresponding address from a database. Operation 1014: Return the address information to the server. Operation 1015: Return map information and the address information to a terminal. Operation 1016: Open a map page, and display corresponding location information on the map. When the address card is clicked, the service background requests the corresponding point of interest data, and the client opens the map page to present a location and information corresponding to the geographical information.

In some embodiments, refer to FIG. 11. Operation 1101: Perform maintenance processing on point of interest data. Operation 1102: Perform maintenance processing on an address feature, and a service background maintains an address feature service. Operation 1103: Provide an address feature recognition service for a terminal. Operation 1104: Click an image, and recognize a text in the image. When the image is viewed, the text in the image is recognized by using an OCR technology, and a field that conforms to the address feature is selected as a keyword. Operation 1105: Return a character that conforms to the address feature. When the inputted text conforms to the address feature, the service background queries the point of interest data by using the inputted keyword, to search for whether there is matching point of interest data. Operation 1106: Search for the point of interest data matched with the character. Operation 1107: Return at least one piece of point of interest data to a server. Operation 1108: return at least one piece of point of interest data (an address result) to a terminal. Operation 1109: Mark the geographical information in the image as a hyperlink that can be clicked to view. Operation 1110: Superimpose, on the current image, an annotation style at a location corresponding to the geographical information, return, by a database, a matching result to the client through a service background, and superimpose and annotate, on the current image, a clickable hyperlink style at a corresponding location. The original image is not affected and modified by this process. Operation 1111: Click the hyperlink to view an address. Operation 1112: Request map information corresponding to address from the server. Operation 1113: Request address information corresponding to the address from a database. Operation 1114: Return the address information to the server. Operation 1115: Return the map information and the address information to the terminal. Operation 1116: Open a map page, and display corresponding location information on a map. When a user clicks a hyperlink, the service background requests the corresponding point of interest data, and the client opens the map page to present the location and information corresponding to a place.

The foregoing address feature recognition may be processed locally by the client, or may be processed by the server.

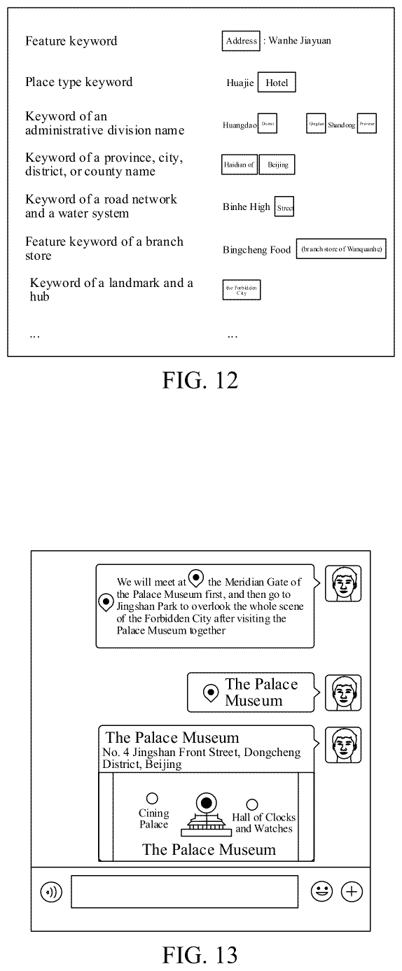

In some embodiments, to avoid excessive recommendation of places to disturb the normal content input by a user, and ensure the correct recognition of the address in the image, an address feature recognition algorithm is provided in some embodiments. The address corresponding to the geographical information is presented to the user only when the content inputted by the user conforms to the address feature. The algorithm performs the address feature recognition by using extensible keywords in different dimensions in deep learning. Referring to FIG. 12, feature keywords: If the keywords such as clear addresses, places, and locations appear in the inputted content, it is considered that fields after the keywords have the address feature. Place type keywords: If the keywords of place types such as hotels, shopping malls, schools, and restaurants appear in the inputted content, it is considered that the input content has the address feature. Administrative division keyword: If administrative division such as a province, a city, a district, a county, an autonomous district, a banner, a street, a town, or a village is inputted, it is considered that the inputted content has the address feature; Landmark hub keywords: If landmark or transportation hub keywords such as the Forbidden City, the Olympic Forest Park, the South Station, and an entrance A are inputted, it is considered that the inputted content has the address feature. The address feature recognition algorithm may have more dimensions, which include, but are not limited to, a range of place types, administrative divisions, provinces, cities, districts, counties, road networks, water systems, branch stores, landmarks, and hubs that are listed above.

In some embodiments, to achieve the natural and smooth user experience, some embodiments are presented as follows at a user interface side: Each time when a user enters text or clicks an image, the place address information (geographical information) in the text/image may be automatically annotated as a clickable style. For evaluation from technical perspectives, each image may be recognized automatically, or a switch may be set for an automatic recognition function. In addition to the automatic recognition, it may be set to support manual click recognition by a user. For example, when a manual recognition mode is used, the image is recognized in response to a trigger operation performed by the user on the image, and the geographical information included in the image is recognized, thereby effectively reducing the consumption of computational power.

In some embodiments, based on a natural text input or image viewing behavior of a user dialog, an address is matched and recommended in real time. This simplifies an address transmitting operation, and offers a more convenient and intuitive way for both an information sender and an information receiver to transmit and view address information. The user can transmit locations while chatting by typing and view the address by opening the image.

In some embodiments, the transmission of plain-text address information can be reduced, whereby the information receiver can receive more address cards or hyperlinks that can be directly clicked to view. This saves a complex procedure of copying text and searching for the place, and improves the user experience of both the information sender and receiver.

Compared with the OCR technology, in some embodiments, optimization is performed on the address scene, and by means of automatic recognition when a user views the image, and direct annotation on the original image, the existing operation procedures are simplified, a learning threshold is lowered, and the user experience is improved.

In some embodiments, a social chat tool may be used, thereby improving the information acquisition efficiency of the information receiver without changing the use habit of the information sender, and further improving the communication efficiency.

Referring to FIG. 13, an address card provided in some embodiments may have various forms. Besides the card with a map style shown in FIG. 5, an address result corresponding to geographical information may be displayed by using a hyperlink, and the hyperlinks of a plurality of places may be displayed in a paragraph of text. There may be various hyperlink styles. In addition to a dashed line box, the hyperlink may further be another clickable style such as an underlining, italicized text that turns blue, or an arrow displayed at the end.

During the application of some embodiments in products or technologies, relevant data involving in user information in some embodiments use the permission or consent of the user, and the collection, use and processing of relevant data should comply with relevant laws, regulations and standards of relevant countries and districts.

The following continues to describe an exemplary structure in which an information display apparatus 455 provided in some embodiments is implemented as a software module. In some embodiments, as shown in FIG. 3, the software module in the information display apparatus 455 stored in a memory 450 may include: a first display module, configured to display to-be-recognized information on a human-computer interaction interface configured to provide text information for reading, the human-computer interaction interface being configured to provide the text information for reading; a second display module, configured to display, when the to-be-recognized information is recognized as including geographical information, annotated information configured for indicating the geographical information on the human-computer interaction interface, the annotated information being configured for performing human-computer interaction processing on the geographical information when triggered.

In some embodiments, the first display module is further configured to: perform any one of the following processing: displaying viewed text information as the to-be-recognized information on the human-computer interaction interface in response to a text viewing operation; displaying inputted text information as the to-be-recognized information in a text input area of the human-computer interaction interface in response to a text input operation; and displaying at least one candidate image, the candidate image including text information, and displaying a preview image as the to-be-recognized information on the human-computer interaction interface in response to an image preview operation, the image being derived from the at least one candidate image.

In some embodiments, the second display module is further configured to: display, when there is one piece of geographical information, at least one piece of annotated information on a human-computer interaction interface in a manner independent from the to-be-recognized information, the at least one piece of annotated information being configured for indicating the geographical information; display, when there is a plurality of pieces of geographical information, at least one piece of annotated information on the human-computer interaction interface in a manner independent from the to-be-recognized information for each geographical information, the at least one piece of annotated information being configured for indicating the geographical information.

In some embodiments, the second display module is further configured to: displaying a place name and address information corresponding to the place name in an area independent from the to-be-recognized information on the human-computer interaction interface, the place name being matched with the geographical information.

In some embodiments, the second display module is further configured to: arrange and display, when there is a plurality of pieces of annotated information, the plurality of pieces of annotated information on the human-computer interaction interface according to a particular order of the plurality of pieces of annotated information, the particular order including at least one of the following: a descending order of matching degrees between the annotated information and the geographical information, a descending order of a number of times of performing the human-computer interaction processing on the annotated information, and a descending order of detailed degrees of the annotated information.

In some embodiments, the second display module is further configured to: display, when there is a plurality of pieces of annotated information, the plurality of pieces of annotated information on the human-computer interaction interface based on a significance level of differentiation, the significance level of the annotated information being in positive correlation with a first feature parameter of the annotated information, and the first feature parameter including at least one of the following: a matching degree between the annotated information and the geographical information, a number of times of performing the human-computer interaction processing on the annotated information, and a detailed degree of the annotated information.

In some embodiments, the second display module is further configured to: display, on the geographical information, the annotated information corresponding to the geographical information in a covering manner; or performing special effect rendering processing on the geographical information, and displaying an obtained special effect rendering style as the annotated information, an area in which the geographical information is located being in a triggerable state.

In some embodiments, when the to-be-recognized information is to-be-transmitted information, the second display module is further configured to: transmit, after displaying the annotated information configured for indicating the geographical information on the human-computer interaction interface, a geographical information query entry to a target account in response to a trigger operation for the annotated information, and display the geographical information query entry on the human-computer interaction interface; and display a map in response to a trigger operation for the geographical information query entry, and mark and display a location of the geographical information on the map.

In some embodiments, when there is a plurality of pieces of geographical information, the second display module is further configured to: displaying a plurality of pieces of shared information corresponding to the target account on the human-computer interaction interface, each piece of shared information including the geographical information query entry corresponding to one piece of geographical information; or displaying one piece of shared information corresponding to the target account on the human-computer interaction interface, the shared information being obtained by performing replacement processing on the geographical information in the to-be-recognized information, and each piece of geographical information being replaced by the corresponding geographical information query entry.

In some embodiments, the second display module is further configured to: arrange and display, on the human-computer interaction interface, the shared information corresponding to the geographical information according to an order of appearance of the geographical information in the to-be-recognized information; or arrange and display, on the human-computer interaction interface, the shared information corresponding to the geographical information in descending order of a number of times of performing the human-computer interaction processing on the geographical information.

In some embodiments, when the to-be-recognized information is previewed information, the second display module is further configured to: display, after displaying the annotated information configured for indicating the geographical information on the human-computer interaction interface, a map in response to a trigger operation for the annotated information, and mark and display a location of the geographical information on the map.

In some embodiments, when the to-be-recognized information is text, before the displaying annotated information configured for indicating geographical information on the human-computer interaction interface, the second display module is further configured to: perform address feature recognition on the to-be-recognized information to obtain an address feature in the to-be-recognized information; and perform geographical information retrieval processing based on the address feature, to obtain the geographical information matched with the address feature.

In some embodiments, when the to-be-recognized information is an image, before the displaying annotated information configured for indicating geographical information on the human-computer interaction interface, the second display module is further configured to: perform word recognition processing on the to-be-recognized information, to obtain a to-be-recognized text; perform address feature recognition processing on the to-be-recognized text, to obtain an address feature in the to-be-recognized information; and perform geographical information retrieval processing based on the address feature, to obtain the geographical information matched with the address feature.

The following continues to describe an exemplary structure in which an information display apparatus provided in some embodiments is implemented as a software module. In some embodiments, the software module in the information display apparatus may include: a first display module, configured to display to-be-recognized information on a human-computer interaction interface, the to-be-recognized information being other information than electronic map information; a second display module, configured to display, when the to-be-recognized information is recognized as including geographical information, annotated information configured for indicating the geographical information on the human-computer interaction interface, the annotated information being configured for performing human-computer interaction processing on the geographical information when triggered.

Some embodiments provide a computer program product. The computer program product includes a computer-executable instruction. The computer-executable instruction is stored in a computer-readable storage medium. A processor of an electronic device reads the computer-executable instruction from the computer-readable storage medium, and the processor executes the computer-executable instruction to cause the electronic device to perform the information display method according to some embodiments.

Some embodiments provide a computer-readable storage medium having a computer-executable instruction stored therein, where the computer-executable instruction, when executed by a processor, causes the processor to perform the information display method according to some embodiments, such as the information display method shown in FIG. 4A to FIG. 4D.

In some embodiments, the computer-readable storage medium may be a memory such as an FRAM, a ROM, a PROM, an EPROM, an EEPROM, a flash memory, a magnetic memory, a compact disc, and a CD-ROM; or the computer-readable storage medium may be various devices including one of or any combination of the foregoing memories.

In some embodiments, the computer-executable instruction may be written in a form of a program, software, a software module, a script, or code according to a programming language (including a compiler or interpreter language or a declarative or procedural language) in any form, and may be deployed in any form, including an independent program or a module, a component, a subroutine, or another unit for use in a computing environment.

As an example, the computer-executable instruction may, but do not necessarily, correspond to a file in a file system, and may be stored in a part of a file that saves another program or other data. For example, the computer-executable instruction may be stored in one or more scripts in a hyper text markup language (HTML) file, stored in a file that is configured for a program in discussion, or stored in a plurality of collaborative files (for example, stored in files of one or more modules, subprograms, or code parts).

As an example, the computer-executable instruction may be deployed to be executed on a computer device, or on a plurality of electronic devices located at a place, or on a plurality of electronic devices distributed at a plurality of places and interconnected through a communication network.

According to some embodiments, each time when the to-be-recognized information such as the text or the image is displayed, the geographical information in the to-be-recognized information is automatically recognized, and the annotated information configured for indicating the geographical information is displayed. The annotated information is configured for performing the human-computer interaction processing on the geographical information when triggered. As a result, the geographical information can be annotated from the to-be-recognized information, the annotated information can be triggered for performing the human-computer interaction processing, and accordingly the efficiency of human-computer interaction performed by the user on the geographical information can be improved.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. An information display method, performed by an electronic device, the method comprising:
displaying to-be-recognized information on a human-computer interaction interface, the human-computer interaction interface being configured to provide text information for reading; and
displaying, based on the to-be-recognized information comprising geographical information, annotated information indicating the geographical information on the human-computer interaction interface,
wherein the annotated information is configured for performing human-computer interaction processing on the geographical information when triggered.

2. The information display method according to claim 1, wherein the displaying the to-be-recognized information comprises at least one of:
displaying viewed text information as the to-be-recognized information on the human-computer interaction interface in response to a text viewing operation;
displaying inputted text information as the to-be-recognized information in a text input area of the human-computer interaction interface in response to a text input operation; and
displaying at least one candidate image, the at least one candidate image comprising first text information, and displaying a preview image as the to-be-recognized information on the human-computer interaction interface in response to an image preview operation, the preview image being derived from the at least one candidate image.

3. The method according to claim 1, wherein the displaying the annotated information comprises:
displaying, based on the geographical information comprising one piece of geographical information, at least one first piece of annotated information on the human-computer interaction interface in a manner independent from the to-be-recognized information, the at least one first piece of annotated information indicating the geographical information; and
displaying, based on the geographical information comprising a plurality of pieces of geographical information, at least one second piece of annotated information on the human-computer interaction interface for each of the plurality of pieces of geographical information in a manner independent from the to-be-recognized information, the at least one second piece of annotated information indicating the geographical information.

4. The method according to claim 3, wherein the annotated information comprises at least one of: a place name, address information corresponding to the place name, or a map identifier representing the place name, and
wherein the place name and the address information are matched with the geographical information.

5. The method according to claim 3, wherein the displaying the at least one second piece of annotated information comprises:
arranging and displaying a plurality of pieces of annotated information on the human-computer interaction interface according to an order of the plurality of pieces of annotated information, and
wherein the order comprises at least one of: a descending order of matching degrees between the annotated information and the geographical information, a descending order of a number of times of performing the human-computer interaction processing on the annotated information, or a descending order of detailed degrees of the annotated information.

6. The method according to claim 3, wherein the displaying, the at least one second piece of annotated information comprises:
displaying a plurality of pieces of annotated information on the human-computer interaction interface based on a significance level of differentiation, and
wherein the significance level of the annotated information is positively correlated with a first feature parameter of the annotated information, and wherein the first feature parameter comprises at least one of: a matching degree between the annotated information and the geographical information, a number of times of performing human-computer interaction on the annotated information, or a detailed degree of the annotated information.

7. The method according to claim 1, wherein the displaying the annotated information comprises:
displaying, on the geographical information, the annotated information in a covering manner; or
performing special effect rendering processing on the geographical information, and displaying an obtained special effect rendering style as the annotated information,
wherein an area in which the geographical information is located is in a triggerable state.

8. The method according to claim 1, wherein the method further comprises:
transmitting a geographical information query entry to a target account based on a first trigger operation for the annotated information, and displaying the geographical information query entry on the human-computer interaction interface; and
displaying a map in response to a second trigger operation for the geographical information query entry, and marking and displaying a location of the geographical information on the map.

9. The method according to claim 8, wherein based on the geographical information comprising a plurality of pieces of geographical information, the displaying the geographical information query entry comprises:
displaying a plurality of pieces of shared information corresponding to the target account on the human-computer interaction interface, a first piece of the shared information comprising a first geographical information query entry corresponding to one piece of geographical information; or
displaying one piece of shared information corresponding to the target account on the human-computer interaction interface, the shared information being obtained by performing replacement processing on the geographical information, and a second piece of the geographical information being replaced by a corresponding geographical information query entry.

10. The method according to claim 9, wherein the displaying the plurality of pieces of shared information comprises:
displaying the shared information corresponding to the geographical information on the human-computer interaction interface in an order of appearance of the geographical information in the to-be-recognized information; or
arranging and displaying, on the human-computer interaction interface, the shared information corresponding to the geographical information in descending order of a number of times of performing human-computer interaction processing on the geographical information.

11. An information display apparatus, the apparatus comprising:
at least one memory configured to store computer program code; and
at least one processor configured to read the program code and operate as instructed by the program code, the program code comprising:
first display code configured to cause at least one of the at least one processor to display to-be-recognized information on a human-computer interaction interface, the human-computer interaction interface being configured to provide text information for reading; and
second display code configured to cause at least one of the at least one processor to display, based on the to-be-recognized information comprising geographical information, annotated information indicating the geographical information on the human-computer interaction interface,
wherein the annotated information is configured for performing human-computer interaction processing on the geographical information when triggered.

12. The information display apparatus according to claim 11, wherein the first display code configured to cause at least one of the at least one processor to perform at least one of:
displaying viewed text information as the to-be-recognized information on the human-computer interaction interface in response to a text viewing operation;
displaying inputted text information as the to-be-recognized information in a text input area of the human-computer interaction interface in response to a text input operation; and
displaying at least one candidate image, the at least one candidate image comprising first text information, and displaying a preview image as the to-be-recognized information on the human-computer interaction interface in response to an image preview operation, the preview image being derived from the at least one candidate image.

13. The apparatus according to claim 11, wherein the second display code is configured to cause at least one of the at least one processor to:
display, based on the geographical information comprising one piece of geographical information, at least one first piece of annotated information on the human-computer interaction interface in a manner independent from the to-be-recognized information, the at least one first piece of annotated information indicating the geographical information; and
display, based on the geographical information comprising a plurality of pieces of geographical information, at least one second piece of annotated information on the human-computer interaction interface for each of the plurality of pieces of geographical information in a manner independent from the to-be-recognized information, the at least one second piece of annotated information indicating the geographical information.

14. The apparatus according to claim 13, wherein the annotated information comprises at least one of: a place name, address information corresponding to the place name, or a map identifier representing the place name, and
wherein the place name and the address information are matched with the geographical information.

15. The apparatus according to claim 13, wherein the second display code is configured to cause at least one of the at least one processor to arrange and display a plurality of pieces of annotated information on the human-computer interaction interface according to an order of the plurality of pieces of annotated information, and
wherein the order comprises at least one of: a descending order of matching degrees between the annotated information and the geographical information, a descending order of a number of times of performing the human-computer interaction processing on the annotated information, or a descending order of detailed degrees of the annotated information.

16. The apparatus according to claim 13, wherein the second display code is configured to cause at least one of the at least one processor to display a plurality of pieces of annotated information on the human-computer interaction interface based on a significance level of differentiation, and
wherein the significance level of the annotated information is positively correlated with a first feature parameter of the annotated information, and wherein the first feature parameter comprises at least one of: a matching degree between the annotated information and the geographical information, a number of times of performing human-computer interaction on the annotated information, or a detailed degree of the annotated information.

17. The apparatus according to claim 11, wherein the second display code is configured to cause at least one of the at least one processor to:
display, on the geographical information, the annotated information in a covering manner; or
perform special effect rendering processing on the geographical information, and displaying an obtained special effect rendering style as the annotated information,
wherein an area in which the geographical information is located is in a triggerable state.

18. The apparatus according to claim 11, wherein the program code further comprises trigger code configured to cause at least one of the at least one processor to:
transmit a geographical information query entry to a target account based on a first trigger operation for the annotated information, and displaying the geographical information query entry on the human-computer interaction interface; and
display a map in response to a second trigger operation for the geographical information query entry, and marking and displaying a location of the geographical information on the map.

19. The apparatus according to claim 18, wherein the trigger code configured to cause at least one of the at least one processor to, based on the geographical information comprising a plurality of pieces of geographical information:
display a plurality of pieces of shared information corresponding to the target account on the human-computer interaction interface, a first piece of the shared information comprising a first geographical information query entry corresponding to one piece of geographical information; or
display one piece of shared information corresponding to the target account on the human-computer interaction interface, the shared information being obtained by performing replacement processing on the geographical information, and a second piece of the geographical information being replaced by a corresponding geographical information query entry.

20. A non-transitory computer-readable storage medium, storing computer code which, when executed by at least one processor, causes the at least one processor to at least:
display to-be-recognized information on a human-computer interaction interface, the human-computer interaction interface being configured to provide text information for reading; and
display, based on the to-be-recognized information comprising geographical information, annotated information indicating the geographical information on the human-computer interaction interface,
wherein the annotated information is configured for performing human-computer interaction processing on the geographical information when triggered.
